(19) United States
(12) Patent Application Publication
(10) Pub. No.: US 2017/0245724 A1
(43) Pub. Date: Aug. 31, 2017

(54) HYDROPHILIC OPEN CELL FOAM

(71) Applicant: 3M INNOVATIVE PROPERTIES COMPANY, St. Paul, MN (US)

(72) Inventors: Tony R. Carrozzella, Ontario (CA); Ibrahim S. Gunes, Minneapolis, MN (US); Nelson R. Costa, Sao Paulo (BR)

(21) Appl. No.: 15/511,476

(22) PCT Filed: Sep. 17, 2015
(86) PCT No.: PCT/US2015/050559

§ 371 Date: Mar. 15, 2017

Related U.S. Application Data
(60) Provisional application No. 62/051,515, filed on Sep. 17, 2014.

(51) Int. Cl. A47L 13/16; C08G 18/76; C08G 18/48; C08G 18/50; B01J 20/26; C08G 18/66; C08G 18/20; C08G 18/18; C08G 18/12; C08J 9/00; C08G 18/08; C08G 18/32

(52) U.S. Cl. CPC A47L 13/16; C08G 18/14; C08G 18/7671; C08G 18/4812; C08G 18/5072; C08G 18/4829; C08G 18/3275; C08G 18/6688; C08G 18/2063; C08G 18/1808; C08G 18/12; C08J 9/00; B01J 20/262; C08G 2101/0083

(57) ABSTRACT

Embodiments herein are related to hydrophilic open cell foams. In an embodiment, an article is included having an open cell foam structure. The open cell foam structure can include a hydrophilic polyurethane polymer comprising a reaction product of a polyol and/or polyamine component and an isocyanate, the polyol and/or polyamine component comprising a mixture of functionalized and non-functionalized polyols and/or polyamines in a ratio by weight of about 5:95 to about 95:5 of functionalized to non-functionalized.

### BACKGROUND

Hydrophilic foams have many industrial and consumer applications. By way of example, hydrophilic foams having an open cell structure can be used to absorb water. Some types of hydrophilic foams can exhibit reversible water absorption. For example, after water absorption into the open cell network, water can be released by applying pressure to the open cell structure. In this manner, such hydrophilic foams can be used to take up water and then release it and be used as sponges for various cleaning applications.

Hydrophilic foams can be formed of various materials, including both natural and synthetic materials. In particular, polymeric materials can be used to form hydrophilic foams. By way of example, cellulose is a common material used in forming hydrophilic foams.

### SUMMARY

Embodiments herein are related to hydrophilic open cell foams. In an embodiment, an article is included having an open cell foam structure. The open cell foam structure can include a hydrophilic polyurethane polymer comprising a reaction product of a polyol and/or polyamine component and an isocyanate, the polyol and/or polyamine component comprising a mixture of functionalized and non-functionalized polyols and/or polyamines in a ratio by weight of about 5:95 to about 95:5 of functionalized to non-functionalized.

In an embodiment, an article is included having an open cell foam structure that includes a polyurethane polymer comprising a reaction product of a polyol component and an isocyanate, the polyol component comprising a mixture of at least about 10 wt. % polyols that include a functional group that is charged at a neutral pH in aqueous solution and at least about 40 wt. % polyols that lack a functional group that is charged at a neutral pH in aqueous solution.

In an embodiment, an article is included having an open cell foam structure that includes a polyurethane polymer comprising a reaction product of a polyol component and an isocyanate, the polyol component comprising a mixture of at least about 10 wt. % sulfonated polyols and at least about 40 wt. % non-sulfonated polyols.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

Embodiments may be more completely understood in connection with the following drawings, in which:

FIG. 1 is a schematic cross-sectional view of an article in accordance with various embodiments herein;

FIG. 2 is a schematic cross-sectional view of an article in accordance with various embodiments herein; and

FIG. 3 is a schematic cross-sectional view of an article in accordance with various embodiments herein.

While embodiments herein are susceptible to various modifications and alternative forms, specifics thereof have been shown by way of example and drawings, and will be described in detail. It should be understood, however, that the embodiments are not limited to the particular embodiments described. On the contrary, the intention is to cover modifications, equivalents, and alternatives falling within the spirit and scope of that described herein.

### DETAILED DESCRIPTION

As described above, hydrophilic foams with open cell structures have many applications. Many existing foam products rely upon cellulose-based hydrophilic foams. Other types of hydrophilic foams can be more economical than cellulose-based hydrophilic foams. However, many previous non-cellulosic hydrophilic foams have not had sufficient functional properties to represent a viable substitute for cellulose-based hydrophilic foams.

Embodiments here are directed to hydrophilic foams with open cell structures that exhibit desirable functional properties. By way of example, in various embodiments herein, hydrophilic foams can include one or more properties such as being flexible and soft even when dry, exhibiting high strength, exhibiting high stability and low shrinkage.

The term “polyurethane polymer” as used herein shall include those polymers including urethane groups therein and thus includes polyurethane/polyurea polymers, unless the context dictates otherwise.

Various embodiments will now be described in detail, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Hydrophilic foams herein can include: polyurethane foams, polyurea foams, polyurethane/polyurea foams, polyester polyurethane foams, and the like.

Hydrophilic foams can be made in various ways. In the context of polyurethanes, one approach is a one-step (or “one shot”) process, in which all components are mixed simultaneously and the mixture is converted into the foam product through the reaction of isocyanate with a polyol (or polyhydroxy compound) to create the polymer and isocyanate with water to produce CO₂ gas to blow the foam. Exemplary polyols used herein can include polyester polyols, polyether polyols, polyester-polyether polyols, polyalkylene polyols, and polycaprolactone polyols. Alternatively, a two-step (or “prepolymer process”) can be used in which a polyol component can be reacted with an excess of isocyanate to obtain an isocynate terminated prepolymer. Then in a second step the prepolymer is reacted with a short polyol, water or polyamine called a chain extender or curing agent to obtain the foam product. Amine catalysts are frequently used to catalyze the isocyanate-water reaction (“blowing catalyst”) and tin or other metal catalysts can be used to regulate the rate of the isocyanate-polyol reaction (“gelling catalyst”). Polyureas can be similarly formed through the reaction of a di- or poly-isocyanate with a polyamine. Polyurethane/polyurea hybrids can be formed through the reaction of a di- or poly-isocyanate with a blend of amine-terminated polymer resin and hydroxyl containing polyols.

Embodiments herein include foams made from combinations of both functionalized and non-functionalized polyols and/or polyamines. In various embodiments, the polyol and/or polyamine component can include a ratio of functionalized (such as, but not limited to, sulfonated) polyol and/or polyamine to non-functionalized (such as, but not limited to, non-sulfonated) polyol and/or polyamine of about 1:99, 5:95, 10:90, 20:80, 30:70, 40:60, 50:50, 60:40, 70:30, 80:20, 90:10, 95:5, or 99:1. In various embodiments, the polyol and/or polyamine component in the hydrophilic foam can include a mixture of functionalized and non-functionalized polyols or polyamines in a range wherein any of the preceding ratios can serve as the upper or lower bound of the range. By way of example, in various embodiments, the polyol component in the hydrophilic foam can include a mixture of functionalized and non-functionalized polyols in a ratio by weight of about 10:90 to about 90:10 of functionalized polyol to non-functionalized polyols.

In various embodiments, the mixture of functionalized and non-functionalized polyols and/or polyamines can include an amount of functionalized polyols and/or polyamines of between about 5 wt. % and about 95 wt. %. In various embodiments, the mixture of functionalized and non-functionalized polyols and/or polyamines can include an amount of functionalized polyols and/or polyamines of between about 10 wt. % and about 90 wt. %. In various embodiments, the mixture of functionalized and non-functionalized polyols and/or polyamines can include an amount of functionalized polyols and/or polyamines of between about 15 wt. % and about 85 wt. %. In various embodiments, the mixture of functionalized and non-functionalized polyols and/or polyamines can include an amount of functionalized polyols and/or polyamines of between about 20 wt. % and about 80 wt. %. In various embodiments, the mixture of functionalized and non-functionalized polyols and/or polyamines can include an amount of functionalized polyols and/or polyamines of between about 20 wt. % and about 60 wt. %. In various embodiments, the mixture of functionalized and non-functionalized polyols and/or polyamines can include an amount of functionalized polyols and/or polyamines of between about 25 wt. % and about 75 wt. %. In various embodiments, the mixture of functionalized and non-functionalized polyols and/or polyamines can include an amount of functionalized polyols and/or polyamines of between about 30 wt. % and about 70 wt. %. In various embodiments, the mixture of functionalized and non-functionalized polyols and/or polyamines can include an amount of functionalized polyols and/or polyamines of between about 30 wt. % and about 50 wt. %. In various embodiments, the mixture of functionalized and non-functionalized polyols and/or polyamines can include an amount of functionalized polyols and/or polyamines of between about 35 wt. % and about 65 wt. %.

In various embodiments, the polyol component can include at least about 10 wt. % sulfonated polyols, or at least about 15 wt. % sulfonated polyols, or at least about 20 wt. % sulfonated polyols, or at least about 25 wt. % sulfonated polyols, or at least about 30 wt. % sulfonated polyols, or at least about 35 wt. % sulfonated polyols, or at least about 40 wt. % sulfonated polyols, or at least about 45 wt. % sulfonated polyols, or at least about 50 wt. % sulfonated polyols. In various embodiments, the polyol component can include at least about 40 wt. % non-sulfonated polyols, or at least about 45 wt. % non-sulfonated polyols, or at least about 50 wt. % non-sulfonated polyols, or at least about 55 wt. % non-sulfonated polyols, or at least about 60 wt. % non-sulfonated polyols, or at least about 65 wt. % non-sulfonated polyols, or at least about 70 wt. % non-sulfonated polyols, or at least about 75 wt. % non-sulfonated polyols.

### Functionalized Polyols and Polyamines

Embodiments herein can specifically include polyols, polyamines, and/or isocyanate terminated prepolymers that include various functional groups. As such, polyols, polyamines and/or prepolymers herein can include functionalized polyols, functionalized polyamines, and/or functionalized prepolymers. As an example, polyols, polyamines and/or prepolymers herein can include those functionalized with a group that is negatively charged at a neutral pH. As a specific example, polyols, polyamines and/or prepolymers herein can include sulfonated polyols (e.g., a polyol with sulfonate functional groups), sulfonated polyamines, and/or sulfonated prepolymers. In various embodiments, the resulting hydrophilic polymer can be a sulfonated polyurethane polymer, sulfonated polyurea polymer, or sulfonated polyurethane/polyurea polymer.

Exemplary sulfonated polyols, sulfonated polyamines, sulfonated prepolymers, and resulting sulfonated polyurethane and polyurea polymers are described in U.S. Pat. No. 4,638,017, the content of which is herein incorporated by reference.

It will be appreciated that such compounds can be formed according to various methods. One approach is shown below in the following reaction diagram:

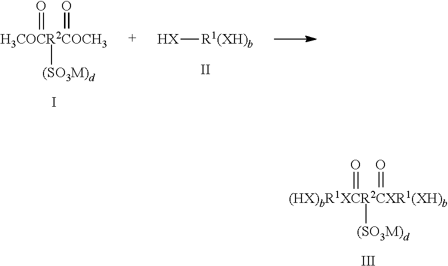

wherein

R¹ is a linear aliphatic group having a valence of (b+1) consisting of a saturated chain of up to 110 carbon atoms in units of 2 to 12 —CH2— groups which can be separated by individual oxygen atoms,

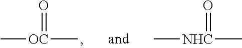

groups, the aliphatic group having a molecular weight of up to 2000, wherein b is 1, 2, or 3; and

R² has a valence of (d+2) and is an arenepolyyl group (polyvalent arene group having 6 to 20 carbon atoms or an alkanepolyyl (polyvalent alkane) group having 2 to 20 carbon atoms, wherein d is 1, 2, or 3,

X is independently —O— or —NH—, and

M is a cation.

Further aspects of such reactions can be found in U.S. Pat. No. 4,638,017, the content of which is herein incorporated by reference.

In various embodiments, the functionalized polyol or polyamine can be of the structure (III):

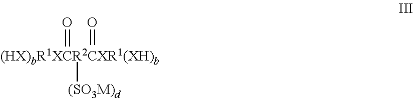

wherein

R¹ is a linear aliphatic group having a valence of (b+1) consisting of a saturated chain of up to 110 carbon atoms in units of 2 to 12 —CH₂— groups which can be separated by individual oxygen atoms,

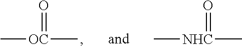

groups, the aliphatic group having a molecular weight of up to 2000, wherein b is 1, 2, or 3; and

R² has a valence of (d+2) and is an arenepolyyl group (polyvalent arene group having 6 to 20 carbon atoms or an alkanepolyyl (polyvalent alkane) group having 2 to 20 carbon atoms, wherein d is 1, 2, or 3,

X is independently —O— or —NH—, and

M is a cation.

In various embodiments, the functionalized polyol or polyamine can have a molecular weight of between about 60 and about 10,000. In various embodiments, the functionalized polyol or polyamine can have a molecular weight of between about 2,000 and about 10,000. In various embodiments, the functionalized polyol or polyamine can have a molecular weight of between about 1,000 and about 6,500. In various embodiments, the functionalized polyol or polyamine can have a molecular weight of about 200 to about 2000. In various embodiments, the functionalized polyol or polyamine can have a molecular weight of about 300 to about 1200.

In various embodiments, the sulfonate equivalent weight (e.g., molecular weight divided by functionality) of the functionalized polyol can be less than about 6000. In various embodiments, the sulfonate equivalent weight (e.g., molecular weight divided by functionality) of the functionalized polyol can be less than about 3000. In various embodiments, the sulfonate equivalent weight (e.g., molecular weight divided by functionality) of the functionalized polyol can be about 2600.

### Non-Functionalized Polyols and Polyamines

Embodiments herein can also specifically include polyols, polyamines, and/or isocyanate terminated prepolymers that lack functional groups other than hydroxyl groups and amine groups. In various embodiments, polyols herein can include those lacking functional groups other than hydroxyl groups. In various embodiments, polyols herein can include those lacking functional groups other than hydroxyl, ether, and ester groups. In various embodiments, polyamines herein can include those lacking functional groups other than amine groups. In various embodiments, polyols, polyamines, and/or isocyanate terminated prepolymers herein can include those lacking functional groups that are charged at a neutral pH. In various embodiments, polyols, polyamines, and/or isocyanate terminated prepolymers herein can include those lacking functional groups that are negatively charged at a neutral pH. As a specific example, polyols and/or prepolymers herein can include non-sulfonated polyols, polyamines, and/or prepolymers. Various polyols, polyamines, and/or prepolymers are commercially available, including, but not limited to those available under the trade names TERATE, CARADOL, BiOH, TERRIN, POLYMEG, and the like.

In various embodiments, the non-functionalized polyol or polyamine can have a molecular weight of between about 60 and about 10,000. In various embodiments, the non-functionalized polyol or polyamine can have a molecular weight of between about 2,000 and about 10,000. In various embodiments, the non-functionalized polyol or polyamine can have a molecular weight of between about 1,000 and about 6,500. In various embodiments, the non-functionalized polyol or polyamine can have a molecular weight of about 1500 to about 4500. In various embodiments, the non-functionalized polyol or polyamine can have a molecular weight of about 2000 to about 4000. In various embodiments, the non-functionalized polyol or polyamine can have a molecular weight of about 2500 to about 3500.

In the context of non-functionalized polyols, the number of isocyanate,-reactive hydroxyl groups per molecule of polyols can be from about 2.0 to about 8.0. In some embodiments, the number of isocyanate-reactive hydroxyl groups per molecule of polyols can be from about 2.0 to about 4.0. In some embodiments, the number of isocyanate-reactive hydroxyl groups per molecule of polyols can be from about 2.0 to about 3.0.

In various embodiments, the non-functionalized polyols or polyamine can be relatively hydrophobic. In various embodiments, the non-functionalized polyols or polyamine can be more hydrophobic than the functionalized polyol or polyamine.

In some embodiments, the non-functionalized polyols or polyamine can have the structure (IV):

HX—R³(XH)_{b} IV

wherein

b is 1, 2, or 3;

R³ is an aliphatic or aromatic carbon chain having a valence of (b+1) and lacking sulfonate functional groups, and interrupted by zero or more heteroatoms, and

X is independently —O— or —NH—.

### Isocyanates

Isocyanates can include di- or poly-isocyanates. Isocyanates can be aromatic or aliphatic. Isocyanates can be a monomer, polymer or any variant reaction of isocyanates, quasi-pre-polymer or a pre-polymer. Exemplary isocyanates can specifically include hexamethylene diisocyanate, toluene diisocyanate (TDI), isophorone diisocyanate, 3,5,5-trimethyl-1-isocyanato-3-isocyanatomethylcyclohexane, 4,4′-diphenylmethane diisocyanate (MDI), 4,4,4″-triisocyanatotriphenylmethane, and the polymethylenepolyphenylisocyanates. Other polyisocyanates can include those described in U.S. Pat. Nos. 3,700,643 and 3,600,359, among others. Mixtures of polyisocyanates can also be used. Exemplary isocyanates are commercially available under the trade names VORALUX, from Dow Chemical Company; CORONATE, from Nippon Polyurethane; LUPRANAT, from BASF Corp.; amongst others.

### Catalysts

Various catalysts can be used. In some embodiments, the catalyst can include amine catalysts, including but not limited to, tertiary amine catalysts. Catalysts can include triethylenediamine; bis(2-dimethylaminoethyl) ether; N,N-dimethylethanolamine; 1,3,5-tris(3-[dimethylamino]propyl)-hexahydro-s-triazine; N,N,N′,N″,N″-pentamethyldiethylenetriamine; N,N-dimethylcyclohexylamine; N,N-dimethylaminoethoxyethanol; 2,2′-dimorpholinodiethylether; and N, N′-dimethylpiperazine; amongst others. In a particular embodiment, the catalyst can be a N-ethylmorpholine (NEM) tertiary amine catalyst with a purity greater than 97% based on GC analysis (commercially available under the vendor catalog number 04500 from Sigma-Aldrich Co., LLC, St. Louis, Mo., USA). Exemplary amine catalysts can also include those commercially available under the tradename TEGOAMIN, from EVONIK Industries.

### Additional Components

It will be appreciated that hydrophilic foams can include various other components in addition to those described above. By way of example, surfactants can be used in various embodiments herein. While not intending to be bound by theory, surfactants can be useful to help regulate cell size in the resulting open cell structure. The surfactants can be nonionic, anionic, cationic, zwitterionic, or amphoteric, alone or in combination. Surfactants can include, but are not limited to, sodium dodecyl sulfate, sodium stearyl sulfate, sodium lauryl sulfate, pluronics, or the like. Examples of surfactants that can be used in hydrophilic foams are described in US Publ. Pat. App. No. 2008/0305983, the content of which relating to surfactants is herein incorporated by reference. Exemplary surfactants are commercially available under the trade names TEGOSTAB, ORTEGOL, from Evonik Goldschmidt Corp., DYNOL, from Air Products & Chemicals, Inc.; PLURONIC, from BASF Corp; TETRONIC, from BASF Corp.; and TRITON X-100, from DOW Chemical Company.

In some embodiments, blowing agents can be included. Blowing agents can include, but are not limited to: C1 to C8 hydrocarbons, C1 and C2 chlorinated hydrocarbons such as methylene chloride, dichloroethene, monofluorotrichloro-methane, difluorodichloromethane, acetone, as well as nonreactive gases such as carbon dioxide, nitrogen, or air.

In various embodiments, dyes or other coloring agents can be used in hydrophilic foams herein. In various embodiments, fire or flame-retardant materials can be included in hydrophilic foams herein. In various embodiments, antimicrobial, antibacterial or antiseptic materials can be included in hydrophilic foams herein. Other components can include fibers, particulates (including, but not limited to, nanosilica particles, nanostarch particles, other polysaccharide particles, cellulose particles, carboxymethyl cellulose particles, and wood particles or wood flour) deodorants, medicinals, alcohols, and the like.

### Articles and Methods

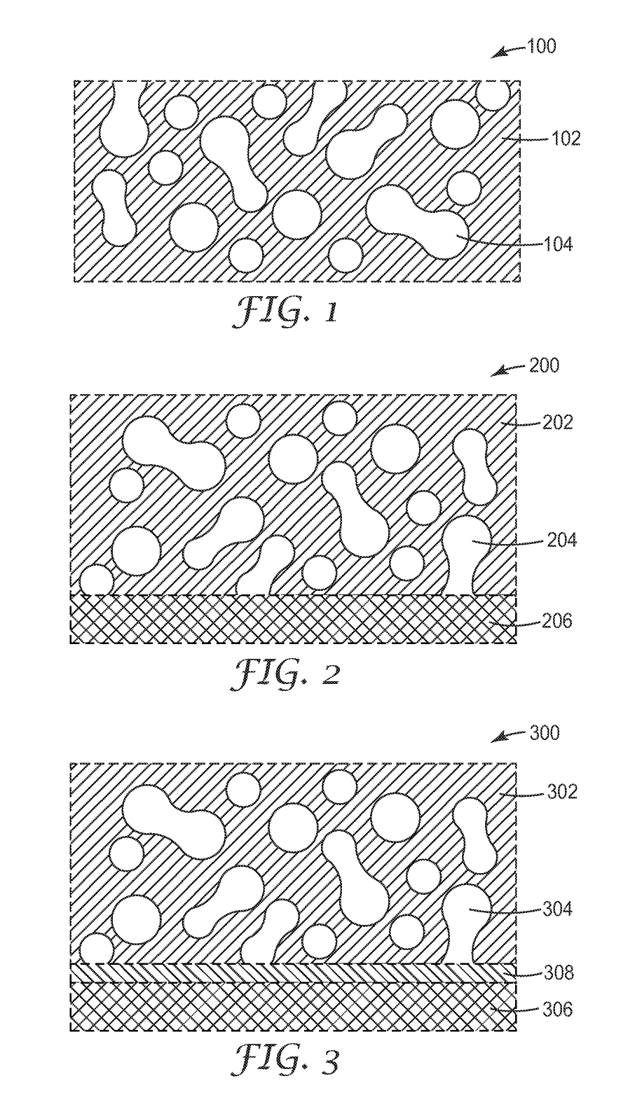

In various embodiments herein, an article is included. The article can include an open cell foam structure. In various embodiments, the open cell foam structure can be in the form of a planar layer. However, it will be appreciated that the open cell foam structure can also take on various other shapes. Referring now to FIG. 1, a schematic cross-sectional view of an article 100 in accordance with various embodiments is shown. The article 100 can include an open cell foam structure 102. The open cell foam structure 102 includes a plurality of interconnected pores 104 into which a fluid, such as water, can be absorbed and then released. In this embodiment, the open cell foam structure 102 is configured as a planar layer.

In some embodiments, an article can include one or more additional layers on one or more sides of the article. Such layers can include various materials, including, but not limited to, woven materials, nonwoven materials, knitted materials, fabrics, foams, sponges, films, printed materials, vapor-deposited materials, plastic netting, and the like.

In some embodiments, an article herein can include a scouring layer. Referring now to FIG. 2, a schematic cross-sectional view of an article 200 in accordance with various embodiments herein is shown. The article 200 can include an open cell foam structure 202. The open cell foam structure 202 can include a plurality of interconnected pores 204 into which a fluid, such as water, can be absorbed and then released. The article 200 can further include a scouring layer 206. In some embodiments, the open cell foam structure 202 can be disposed over the scouring layer 206.

The scouring layer can be formed from various materials. The scouring layer can be made from various materials including, but not limited to: woven, nonwoven, knitted, fabrics, foams, sponges, films, printed materials, vapor-deposited materials, plastic netting, and the like. In some embodiments, the scouring layer can be a coated abrasive layer, a fabric that is pattern-coated or printed with an abrasive resin, or a structured abrasive film. Exemplary materials for scouring layers are described in U.S. Pat. Nos. 4,055,029; 7,829,478; and U.S. Publ. App. No. 2007/0212965.

In some embodiments, the scouring layer can include a lofty, fibrous, nonwoven abrasive product. Exemplary scouring layer materials are described in U.S. Pat. Nos. 4,991,362 and 8,671,503, the contents of which are herein incorporated by reference. The scouring layer can include a porous structure defining pores.

In various embodiments, the scouring layer is directly bonded to the open cell foam structure. By way of example, the composition for forming the hydrophilic foam can be poured onto the scouring layer before the materials of the hydrophilic foam sets up (for example, prior to gel time) such that the hydrophilic foam will be intermixed into the pores of the scouring layer causing the open cell foam structure to be directly bonded to the scouring layer. The open cell foam structure can be at least partially disposed within the pores of the porous structure.

In other embodiments, the scouring layer can be indirectly bonded to the open cell foam structure. By way of example, an adhesive can be used to bond the scouring layer to the open cell foam structure. The adhesive may cover some or the entire surface of the interface between the scouring layer and the open cell foam structure. In some embodiments, the article can include a layer of an adhesive disposed between the scouring layer and the planar layer of the open cell foam structure. Referring now to FIG. 3, a schematic cross-sectional view of an article 300 in accordance with various embodiments herein is shown. The article 300 can include an open cell foam structure 302. The open cell foam structure 302 can include a plurality of interconnected pores 304 into which a fluid, such as water, can be absorbed and then released. The article 300 can further include a scouring layer 306. A layer of an adhesive 308 can further be disposed in between the scouring layer 306 and the layer of the open cell foam structure 302.

In various embodiments, the open cell foam structure and/or articles including the same can exhibit a relatively high maximum tensile load. In some embodiments, the open cell foam structure and/or articles including the same can exhibit a maximum tensile load (ASTM D3574-11, Test-E) of greater than about 0.5 kN/m, or greater than about 0.6 kN/m, or greater than about 0.7 kN/m, or greater than about 0.8 kN/m, or greater than about 0.9 kN/m, or greater than about 1.0 kN/m.

In some embodiments, the open cell foam structure and/or articles including the open cell foam structure can exhibit a desirable wet wipe water holding capacity. By way of example, in some embodiments, the open cell foam structure can exhibit a wet wipe water holding capacity of greater than about 1.0 g/g foam, or greater than about 1.5 g/g foam, or greater than about 2.0 g/g foam, or greater than about 2.5 g/g foam, or greater than about 3.0 g/g foam, or greater than about 3.5 g/g foam. In various embodiments, the open cell foam structure can exhibit a wet wipe water holding capacity that is greater than an otherwise identical open cell foam structure lacking the particulate filler material.

### EXAMPLES

Materials used in examples 1-3 (Samples 1-12) are shown in Table 1.

TABLE 1

| Material | Description |
|---|---|
| “Polyol 1” | Glycerine initiated heteropolymer polyether triol with a molecular |
| | weight of 3000, hydroxyl number 56, viscosity 450 cSt, |
| | polyoxyethylene percentage of around 8%, commercially available |
| | from DOW CHEMICAL COMPANY, Midland, MI, USA under the |
| | trade designation of VORANOL 3010. |
| “Polyol 2” | Sulfonated polyol made as per “Preparatory Example 1” of U.S. Pat. |
| | No. 4,638,017. |
| “Isocyanate” | Aromatic isocyanate which contains diphenyl diisocyanate (MDI) and |
| | which has an NCO content between 29.2-30.4 determined according to |
| | ASTM D5155 test method and commercially available under the trade |
| | designation of VORALUX HE 134 ISOCYANATE from DOW |
| | CHEMICAL COMPANY, Midland, MI, USA. |
| “Surfactant-1” | A polyether-modified polysiloxane, commercially available under the |
| | trade designation of TEGOSTAB B 8228 from EVONIK |
| | GOLDSCHMIDT CORPORATION, Hopewell, VA, USA. |
| “Surfactant-2” | A non-reactive polyether siloxane, commercially available under the |
| | trade designation of ORTEGOL ® HPH 1 from EVONIK |
| | GOLDSCHMIDT CORPORATION, Hopewell, VA, USA. |
| “Catalyst-1” | A tertiary amine catalyst with a viscosity of (at 25° C.) 125 mPas and a |
| | specific gravity of (at 25° C.) 1.03 g/cm3, commercially available |
| | under the trade designation of DABCO 33LV from AIR PRODUCTS |
| | AND CHEMICALS, INC., Allentown, PA, USA. |
| “Catalyst-2” | An amine catalyst commercially available under the trade designation |
| | of TEGOAMIN AS33 from EVONIK GOLDSCHMIDT |
| | CORPORATION, Hopewell, VA, USA. |
| “Chain Extender” | Diethanolamine commercially available under the trade designation of |
| | DABCO DEOA-LF from AIR PRODUCTS AND CHEMICALS, |
| | INC., Allentown, PA, USA. |

### Hydrophilicity Test Procedure:

Prepared foam samples were cut horizontally with the help of a hack saw to expose a fresh foam surface. Then, a droplet of water was placed on the cut surface using a pipette. The water droplet was visually observed for the next 10 seconds following the placement. If the droplet was absorbed by the foam within the 10 seconds, the sample was designated as hydrophilic. If the droplet was not absorbed by the foam and stayed on the surface, the sample was not designated as hydrophilic.

### Example 1

### Formation of Sulfonated Polyol

A one liter flask was fitted with a mechanical stirrer, nitrogen purge, condenser and receiver for condensate. The flask was charged with 1.0 moles (600 g) ethyleneoxide polyol (Carbowax 600™, Union Carbide, Danbury, Conn.), 0.25 moles (24.0 g) dimethyl sodium 5-sulfoisophthatate (previously dried above 100 degrees C., in a vacuum oven), and 100 g toluene. The flask was heated in a Woods metal bath to 130° C. to distill toluene and thus dry the, reactants. When all of the toluene was removed the reactants were heated to 200° C. at which time 0.2 g Zn(OAc)₂ is added (0.03 wt %). Esterification accompanied by the evolution of methanol took place. The temperature was raised to 245° C. for a period of 4 hours, at which time the pressure was reduced to 1 mm for 30 to 60 minutes. Hot resin was then poured into dry containers and capped under dry Neto prevent absorption of water. The OH equivalence of this diol was typically approximately 465 g/mole OH as determined by the NCO method.

### Example 2

### Formation of Hydrophilic Foams

For each experiment, a total of 15 grams of mixture which contained polyols, isocyanate, water, catalyst, and surfactant was used. The ingredients were weighed and placed in plastic containers. The first mixture was obtained as follows: The desired amounts of polyols, water, catalysts, and surfactant were weighed in a plastic cup. Then, in a second cup, isocyanate was weighed. Immediately before the centrifugal mixing, the weighed amount of isocayanate was added to the first mixture and the resulting, final mixture was mixed in the centrifugal mixer (Speedmixer, FlacTek Inc) for 15 seconds at 2000 rpm. Then, the plastic container which had the mixture was taken out of the mixer, the lid was opened, and the foam rising was visually observed. It was determined that foam rising typically completed within 2-5 minutes. The formulations (Samples 1-6) tested are shown below in Table 2.

TABLE 2

| | Contents (wt. %) | | | | | |
|---|---|---|---|---|---|---|
| Sample | 1 | 2 | 3 | 4 | 5 | 6 |
| Polyol 1 | 23.47 | 25.32 | 25.00 | 24.41 | 26.26 | 25.43 |
| Polyol 2 | 23.47 | 25.32 | 25.00 | 24.41 | 26.26 | 25.43 |
| Surfactant 1 | 0.27 | 0.29 | 0.28 | 0.28 | 0.30 | 0.29 |
| Catalyst 1 | 0.80 | 0.29 | 0.00 | 0.28 | 0.15 | 0.29 |
| Deionized | 4.91 | 2.86 | 2.82 | 5.10 | 1.48 | 2.44 |
| water | | | | | | |
| Chain | 0.93 | 1.00 | 1.98 | 1.93 | 1.04 | 1.01 |
| extender | | | | | | |
| Isocyanate | 46.15 | 44.92 | 44.35 | 43.31 | 44.51 | 45.11 |
| Catalyst 2 | 0.00 | 0.00 | 0.56 | 0.00 | 0.00 | 0.00 |
| Surfactant 2 | 0.00 | 0.00 | 0.00 | 0.28 | 0.00 | 0.00 |

The resiliency of each of the foams was tested by compressing the foam between two fingers and visually observing the recovery of the compressed foam. The hydrophilicity was tested as described above.

It was observed that Sample 4 exhibited the best combination of the extent of foam rising, resiliency, and visual appearance among the samples. Limited foam rising was observed with Samples 1, 2, and 3. No proper foaming was observed in Samples 5 and 6.

The hydrophilic nature of Sample 4 was demonstrated by slowly pouring water on Sample 4 and, as a comparative experiment, on the foam layer of O-CEL-O® EXPRESSIONS SCRUBBER, commercially available from 3M Company, St. Paul, Minn., USA, under the catalog number of 9752-E. The poured water was not absorbed by the commercial foam, however the same amount of poured water was immediately absorbed by Sample 4.

### Example 3

### Formation of Hydrophilic Foams with Varying Amounts of Functionalized and Non-Functionalized Polyols

For each experiment, a total of 15 grams of a mixture which contained polyols, isocyanate, water, catalyst, and surfactant was used. The ingredients were weighed and placed in plastic containers. The first mixture was obtained as follows: The desired amounts of polyols, water, catalysts, and surfactant were weighed in a plastic cup. Then, in a second cup, isocyanate was weighed. Immediately before the centrifugal mixing, the weighed amount of isocyanate was added to the first mixture and the resulting, final mixture was mixed in the centrifugal mixer (Speedmixer, FlacTek Inc) for 15 seconds at 2000 rpm. Then, the plastic container which had the mixture was taken out of the mixer, the lid was opened, and the foam rising was visually observed. It was determined that foam rising typically completed within 2-5 minutes. The formulations (Samples 7-12) tested are shown below in Table 3.

TABLE 3

| | Contents (wt. %) | | | | | |
|---|---|---|---|---|---|---|
| Sample | 7 | 8 | 9 | 10 | 11 | 12 |
| Weight ratio | 1/99 | 5/95 | 10/90 | 20/80 | 30/70 | 40/60 |
| of polyol 2 | | | | | | |
| to polyol 1 | | | | | | |
| Polyol 1 | 49.05 | 47.05 | 44.53 | 39.48 | 34.46 | 29.45 |
| Polyol 2 | 0.5 | 2.48 | 4.95 | 9.87 | 14.77 | 19.63 |
| Surfactant 1 | 0.28 | 0.28 | 0.28 | 0.28 | 0.28 | 0.27 |
| Catalyst 1 | 0.28 | 0.28 | 0.28 | 0.28 | 0.28 | 0.27 |
| Deionized | 5.18 | 5.18 | 5.17 | 5.16 | 5.14 | 5.13 |
| water | | | | | | |
| Chain | 1.96 | 1.96 | 1.95 | 1.95 | 1.94 | 1.94 |
| extender | | | | | | |
| Isocyanate | 42.76 | 42.79 | 42.85 | 42.99 | 43.13 | 43.29 |

The resiliency was tested by compressing the foam between two fingers and visually observing the recovery of the compressed foam. The hydrophilicity was tested as described above.

Samples 11 and 12, which had polyol ratios of 30/70 and 40/60 were observed to be hydrophilic. The water droplets placed on these samples were absorbed by the foam within a few seconds. Water droplets placed on other formulations stayed on the foam surface for at least 10 seconds without being absorbed. The results are shown below in Table 4.

TABLE 4

| Formulation | 7 | 8 | 9 | 10 | 11 | 12 |
|---|---|---|---|---|---|---|
| Weight ratio | 1/99 | 5/95 | 10/90 | 20/80 | 30/70 | 40/60 |
| of polyol 2 | | | | | | |
| to polyol 1 | | | | | | |
| Isocyanate | 47.9 | 47.9 | 47.9 | 47.9 | 47.9 | 47.9 |
| index | | | | | | |
| Hydrophilic? | NO | NO | NO | NO | YES | YES |

### Example 4

### Formation of Hydrophilic Foams with Prepolymers

Materials used for this example (Samples 13-17) were as shown in Table 5.

TABLE 5

| Material | Description |
|---|---|
| Prepolymer-1 | Sulfonated prepolymer made as per preparatory |
| | “Example 2” of U.S. Pat. No. 4,638,017. |
| Prepolymer-2 | Hydrophilic polyurethane prepolymer based on MDI, |
| | commercially available under the trade designation of |
| | HYPOL JM 5005 from DOW CHEMICAL COMPANY, |
| | Midland, MI, USA. |
| Surfactant | A non-ionic, difunctional block copolymer surfactant |
| | terminating in primary hydroxyl groups, with an average |
| | molecular weight of 2200 and with a specific gravity of |
| | 1.05 determined at 25C., commercially available under |
| | the trade designation of PLURONIC L44 NF |
| | INH from BASF CORPORATION, Florham Park, |
| | New Jersey, USA. |
| Catalyst | N-ethylmorpholine (NEM) tertiary amine catalyst with a |
| | purity greater than 97% (based on GC analysis) |
| | commercially available under the vendor catalog number |
| | 04500 from SIGMA-ALDRICH CO., LLC, St. Louis, |
| | MO, USA. |
| Yellow | Anionic yellow pigment dispersion with a density of |
| colorant | 1.03 g/cm3 (determined at 20° C.) commercially |
| | available under the trade designation SOLAR YELLOW |
| | 42L from BASF CORPORATION, Florham Park, |
| | New Jersey, USA. |

Samples for this example were prepared according to the following procedure:

1. The catalyst and deionized water were placed in a glass beaker and hand mixed for 5 minutes to obtain a mixture which contained 20 wt % catalyst. This mixture was called the catalyst mixture.

2. A first mixture of tap water and other additives, such as surfactant, catalyst mixture, pigment, and filler was prepared. The ingredients were weighed out to the nearest 0.01 grams and put in a glass beaker. The mixture in the beaker was then mixed by hand for 3-5 minutes until the solution is homogenous.

3. In a separate, polyethylene rigid container, the prepolymers were weighed out to the nearest 0.01 grams.

4. A laboratory bench-top mixer equipped with a 4-propeller blade and which had a blade diameter of 10.2 cm was used in the experiments. The maximum mixer speed was set to 3000 rpm.

5. To prepare the second mixture made of the first mixture and the prepolymers, the mixer was started and the rotating blade was immersed into the polyethylene rigid container which already contained the prepolymers. Care was exercised to prevent the blades from touching the sides and bottom of the container. Once the rotation speed of the mixer reached 3000 rpm, the first mixture was quickly added to the rigid polyethylene container to start mixing of prepolymers with the first mixture. Formulations with varying contents of prepolymer-1 and prepolymer-2 were prepared, as presented in TABLE 6.

6. The first mixture and the prepolymers were mixed for 30 seconds to obtain the second mixture. The blade was moved around the container in a circular motion during mixing. Care was exercised to prevent the blades from touching the sides and bottom of the container.

7. After 30 seconds, the mixer was stopped, the blade was removed out of the container, and the second mixture in the container was left undisturbed on a laboratory bench. The foaming of the second mixture was visually monitored.

8. The foam prepared from the second mixture was left undisturbed for a minimum of 5 minutes at 25 C before it was cut to obtain specimens used in further tests. Rectangular prism-shaped foam samples with approximate dimensions of 12 cm in length, 7.6 cm in width, and 1.5 cm in thickness were cut for further testing.

The as-prepared foam samples which were kept at ambient laboratory temperature and humidity were designated as dry foam samples. Any measurement taken from the dry foam sample was designated as a dry measurement. The ambient temperature in the laboratory was measured to be approximately 25° C. and the ambient humidity was measured to be approximately 50% RH. The samples were then evaluated according to the following test procedures:

### Dry Density:

Foams herein can have various dry densities. In some applications, densities that are of the same order of magnitude as for commercial cellulose foams are desirable. The density of the foams was assessed according to the following procedure.

1. The length, width, and thickness of the as-prepared foam samples were measured to the nearest 0.01 mm with the help of a caliper. If the sample was not uniform in shape, multiple measurements for the length, width and thickness were recorded. The arithmetic mean of multiple measurements for each parameter, length, width, and thickness was used as the representative value in calculation of the sample volume. The volume was calculated by multiplying the length, width, and thickness values of the foam.

2. The weight of the as-prepared foam sample was determined to the nearest 0.01 grams.

3. The dry density was calculated by dividing the measured weight to the calculated volume.

### Dry Wet-Out Time:

The duration of time for a droplet of tap water to be completely absorbed by a dry foam sample was designated as ‘dry wet-out time’. For some applications, a relatively short dry wet-out time can be desirable because a shorter duration can be an indicator of faster water absorption. Dry wet-out time was assessed according to the following procedure.

1. A droplet of tap water was slowly placed on the surface of the dry foam with the help of a pipette.

2. The water droplet was visually observed. The duration of time for the droplet to completely wet out the foam surface was determined with a stopwatch and considered as ‘dry wet-out time’.

3. Water droplets placed on some samples were almost instantaneously absorbed by the sample and no reasonable time measurement was possible. In that case, the dry-wet out time for that sample was recorded as ‘instantaneous’.

### Percent Swell:

The extent of swelling when a dry foam sample was completely submerged in tap water and after it was allowed to soak tap water for one minute was designated as percent swell. It will be appreciated that foams herein can exhibit various amounts of swelling. However, for some applications a relatively lower percent swell can be desirable.

1. The length, width, and thickness of the as-prepared foam samples were measured to the nearest 0.25 mm with the help of a caliper. If the sample was not uniform in shape, multiple measurements for the length, width and thickness were recorded. The arithmetic mean of multiple measurements for each parameter, length, width, and thickness was used as the representative value in calculation of the sample volume. The dry volume was calculated by multiplying the length, width, and thickness values of the dry foam.

2. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/immersion again cycle was repeated five times.

3. After completing five cycles, the foam sample was taken out of water and squeezed by hand pressure to remove as much soaked water as possible. Then, the water in the container was discarded and the container was filled with fresh tap water.

4. The foam sample was completely immersed in tap water in the container and was allowed to soak water for one minute.

5. Then, the foam sample was removed from the container and placed on the lab bench while exercising care not to compress the foam sample.

6. The length, width, and thickness of the foam samples were measured to the nearest 0.25 mm with the help of a caliper. These values were designated as wet dimensions. If the sample was not uniform in shape, multiple measurements for the length, width and thickness were recorded. The arithmetic mean of multiple measurements for each parameter, length, width, and thickness, was used as the representative value in calculation of the sample volume. The wet volume was calculated by multiplying the wet length, width, and thickness values of the foam.

7. The percent swell is calculated by dividing the difference between the wet volume and the dry volume to dry volume and multiplying it by 100.

### Wet Wipe Water Holding Capacity:

Wet wipe water holding capacity can be indicative of how a foam takes up and reversibly holds onto water. A relatively high wet wipe water holding capacity can be useful in various applications including, but not limited to, cleaning applications. The following procedure was used to determine wet wipe water holding capacity.

1. 25 grams of tap water was slowly poured onto a polished stainless steel plate.

2. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/re-immersion cycle was repeated five times.

3. After completing five cycles, the foam sample was taken out of water and squeezed by hand pressure to remove as much soaked water as possible Then, the hand-squeezed foam sample was wrung out with a manual nip roller operated under hand pressure. The nipping action repeated multiple times, until no more water was seen removed. Then, the weight of the wrung foam sample was determined. This weight value was designated as ‘wrung weight’.

4. The wrung foam sample was slowly passed across the water poured on the polished stainless steel plate while the front end of the foam was slightly lifted to facilitate wiping action.

5. After the foam sample was passed across water, the weight of the foam sample which absorbed water was determined. This weight value was designated as the “first pass” weight.

6. The wet wipe water holding capacity was calculated by dividing the difference between the ‘first pass’ and ‘wrung weight’ by ‘wrung weight’.

### Percent Effective Absorption:

Percent effective absorption was the percent of water, by volume, that initially damp foam retained after it reached saturation level of water absorption and after it was left draining for five minutes. Relatively high percent effective absorption can be a useful property in various applications including, but not limited to, cleaning applications. The following procedure was used to determine the total amount of water a foam sample could hold, based on its volume and its damp weight.

1. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/re-immersion cycle was repeated five times.

2. After completing five cycles, the foam sample was taken out of water and squeezed by hand pressure to remove as much soaked water as possible Then, the hand-squeezed foam sample was wrung out with a manual nip roller operated under hand pressure. The nipping action repeated multiple times, until no more water was seen removed. Then, the weight of the wrung foam sample was determined. This weight value was designated as ‘wrung weight’.

3. The wrung foam sample was completely immersed in tap water, while it was being squeezed to remove any entrapped air.

4. The foam sample was relaxed while it was still completely immersed in water, so that it could absorb water. The relaxed foam was left completely immersed in water for approximately one minute.

5. After one minute, the foam sample was removed from water. A binder clip was gently attached to an edge of the sample and the sample was left hanging on a draining rod for five minutes. Care was exercised when handling the sponge not to accidentally squeeze out any water.

6. After 5 minutes, the weight of the sample was determined to the nearest 0.01 gram and recorded as “wet weight.”

7. The percent effective absorption was calculated by dividing the difference between the wet weight and wrung weight by wrung weight and multiplying it by 100.

### Rate of Absorption:

Relatively high rate of absorption can be useful in various applications including, but not limited to, cleaning applications. In this test, the foam sample was placed on its largest face in a container that had 3.2 mm deep tap water. The amount of water that was absorbed by the foam sample within 5 seconds was determined and then a rate of absorption was calculated. The following procedure was used.

1. A rigid plastic container was filled with tap water. A dry foam sample was completely submerged into the container filled with the tap water. Then, the foam sample was taken out of water and squeezed by hand pressure to remove as much soaked water as possible. Then, the squeezed foam sample was immersed once again in tap water. This immersion/squeezing/re-immersion cycle was repeated five times.

2. After completing five cycles, the foam sample was taken out of water and squeezed by hand pressure to remove as much soaked water as possible. Then, the hand-squeezed foam sample was wrung out with a manual nip roller operated under hand pressure. The nipping action repeated multiple times, until no more water was seen removed. Then, the weight of the wrung foam sample was determined. This weight value was designated as ‘wrung weight’.

3. A perforated metal plate was placed in a rigid plastic container. Continuous water flow into and out of the container was facilitated to keep the water depth above the perforated metal plate constant at approximately 3.2 mm.

4. The foam sample was placed on its largest face onto the perforated metal plate and kept at this position for five seconds.

5. After five seconds, the foam sample was removed and its weight was determined to the nearest 0.01 gram. This value was recorded as “wet weight.”

6. The rate of absorption was calculated by dividing the difference between the wet weight and wrung weight by wrung weight and multiplying by 100.

### Tensile Testing:

Relatively high tensile strength is a desirable property of hydrophilic foams. In various applications, higher tensile strength and higher ultimate elongation values can be indicative of greater durability. The maximum tensile load and ultimate elongation values of the foam samples were determined according to the ASTM Standard Test Methods for Flexible Cellular Materials—Slab, Bonded, and Molded Urethane Foams D3574-11, Test-E: Tensile Test.

The formulations (Samples 13-17) tested are shown below in Table 6. The properties of the foam samples were tested according to the test procedures described above and the determined properties are presented in Table 6.

TABLE 6

| | Sample No | | | | |
|---|---|---|---|---|---|
| | 13 | 14 | 15 | 16 | 17 |
| | weight of ingredient in the formulation (grams) | | | | |
| Ingredients | | | | | |
| Prepolymer-1 | 50 | 45 | 40 | 35 | 30 |
| Prepolymer-2 | 0 | 5 | 10 | 15 | 20 |
| Water | 25 | 25 | 25 | 25 | 25 |
| Catalyst | 0.6 | 0.6 | 0.6 | 0.6 | 0.6 |
| Solution | | | | | |
| Surfactant | 0.5 | 0.5 | 0.5 | 0.5 | 0.5 |
| Yellow Colorant | 0.2 | 0.2 | 0.2 | 0.2 | 0.2 |
| Properties | | | | | |
| Dry Wet-Out | Inst. | 1 | 1 | 2 | 9 |
| Time (seconds) | | | | | |
| Density (kg/m3) | 39.9 | 41.5 | 74.5 | 83 | 88.4 |
| % Swell | 16.60 | 25.80 | 40.30 | 44.30 | 51.70 |
| Wet-wipe Water | 3.40 | 3.90 | 2.40 | 1.90 | 2.10 |
| Holding | | | | | |
| Capacity (g/g | | | | | |
| foam) | | | | | |
| % Effective | 50.10 | 77.30 | 49.60 | 81.40 | 125.70 |
| Absorption | | | | | |
| Rate of | 35.30 | 41.70 | 25.30 | 27.90 | 7.80 |
| Absorption | | | | | |
| Maximum | 0.75 | 0.92 | 1.09 | 0.91 | 0.95 |
| Tensile Load | | | | | |
| (kN/m) | | | | | |
| Ultimate | 78 | 80 | 82 | 100 | 117 |
| Elongation (%) | | | | | |

It was observed that the presence of the second prepolymer (“Prepolymer-2”) in addition to the first prepolymer (“Prepolymer-1”) significantly improved the tested tensile properties of the foam samples.

The various embodiments described above are provided by way of illustration only and should not be construed to limit the claims attached hereto. It will be recognized that various modifications and changes may be made without following the example embodiments and applications illustrated and described herein, and without departing from the true spirit and scope of the claims.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains. All publications and patent applications are herein incorporated by reference to the same extent as if each individual publication or patent application was specifically and individually indicated by reference.

1. An article comprising:
an open cell foam structure comprising:
a hydrophilic polyurethane polymer comprising a reaction product of a polyol and/or polyamine component and an isocyanate, the polyol and/or polyamine component comprising a mixture of functionalized and non-functionalized polyols and/or polyamines in a ratio by weight of about 5:95 to about 95:5 of functionalized to non-functionalized.

2. The article of claim 1, the functionalized polyols and/or polyamines comprising functional groups that are charged at a neutral pH.

3. (canceled)

4. The article of claim 1, the functionalized polyols and/or polyamines comprising sulfonate groups.

5. The article of claim 1, the functionalized polyols and/or polyamines having a molecular weight of about 200 to about 2,000.

6. (canceled)

7. The article of claim 1, the functionalized polyols and/or polyamines having the structure (III): 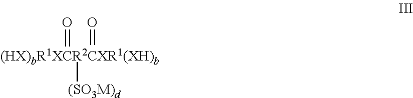
wherein:
R¹ is a linear aliphatic group having a valence of (b+1) consisting of a saturated chain of up to 110 carbon atoms in units of 2 to 12 —CH₂— groups which can be separated by individual oxygen atoms, 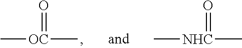
groups, the aliphatic group having a molecular weight of up to 2000, wherein b is 1, 2, or 3; and
R² has a valence of (d+2) and is an arenepolyyl group (polyvalent arene group having 6 to 20 carbon atoms or an alkanepolyyl (polyvalent alkane) group having 2 to 20 carbon atoms, wherein d is 1, 2, or 3,
X is independently —O— or —NH—, and
M is a cation.

8. The article of claim 1, the non-functionalized polyols and/or polyamines lacking functional groups that are charged at a neutral pH.

9. (canceled)

10. The article of claim 1, the non-functionalized polyols and/or polyamines lacking sulfonate functional groups.

11. The article of claim 1, the non-functionalized polyols and/or polyamines having a molecular weight of about 1,000 and about 6,500.

12. (canceled)

13. The article of claim 1, the non-functionalized polyols and/or polyamines having the structure (IV):
HX—R³(XH)_{b} IV
wherein:
b is 1, 2, or 3;
R³ is an aliphatic or aromatic carbon chain having a valence of (b+1) and lacking sulfonate functional groups, and interrupted by zero or more heteroatoms, and
X is independently —O— or —NH—.

14. The article of claim 1, the polyol and/or polyamine component comprising a mixture of functionalized and non-functionalized polyols and/or polyamines in a ratio by weight of about 10:90 to about 90:10 of functionalized to non-functionalized.

15. The article of claim 1, the mixture of functionalized and non-functionalized polyols and/or polyamines comprising an amount of functionalized polyols and/or polyamines greater than about 10 wt. % and less than about 90 wt. %.

16. (canceled)

17. (canceled)

18. The article of claim 1, comprising a sponge.

19. The article of claim 1, the hydrophilic polyurethane polymer comprising a polyurea polyurethane polymer.

20. The article of claim 1, the open cell foam structure comprising a planar layer.

21. The article of claim 20, further comprising a scouring layer, wherein the open cell foam structure is disposed over the scouring layer.

22. The article of claim 21, wherein the scouring layer is directly bonded to the open cell foam structure.

23. (canceled)

24. The article of claim 21, further comprising a layer of an adhesive disposed between the scouring layer and the planar layer of the open cell foam structure.

25. The article of claim 1, the open cell foam structure exhibiting a maximum tensile load (ASTM D3574-11, Test-E) of greater than about 0.5 kN/m.

26. (canceled)

27. An article comprising:
an open cell foam structure comprising:
a polyurethane polymer comprising a reaction product of a polyol component and an isocyanate, the polyol component comprising a mixture of:
at least about 10 wt. % polyols that include a functional group that is charged at a neutral pH in aqueous solution; and
at least about 40 wt. % polyols that lack a functional group that is charged at a neutral pH in aqueous solution.

28. An article comprising:
an open cell foam structure comprising:
a polyurethane polymer comprising a reaction product of a polyol component and an isocyanate, the polyol component comprising a mixture of:
at least about 10 wt. % sulfonated polyols; and
at least about 40 wt. % non-sulfonated polyols.
